(19) United States
(12) Patent Application Publication
(10) Pub. No.: US 2026/0316908 A1
(43) Pub. Date: Oct. 15, 2026

(54) AUTONOMOUS MARINE SYSTEM

(71) Applicant: Garmin International, Inc., Olathe, KS (US)

(72) Inventor: Ravinder Singh, Olathe, KS (US)

(21) Appl. No.: 19/645,808

(22) Filed: Apr. 13, 2026

Related U.S. Application Data
(60) Provisional application No. 63/787,557, filed on Apr. 11, 2025.

(51) Int. Cl. B63B 43/18; B63B 49/00; G05D 1/248; G05D 1/633; G05D 1/65; G05D 103/00; G05D 107/00; G05D 109/30; G05D 111/10; G05D 111/20; G05D 111/30; G05D 111/50; G05D 111/67

(52) U.S. Cl. CPC B63B 43/18; B63B 49/00; G05D 1/248; G05D 1/633; G05D 1/65; B63B 2213/02; G05D 2103/00; G05D 2107/25; G05D 2109/34; G05D 2111/17; G05D 2111/20; G05D 2111/30; G05D 2111/52; G05D 2111/67

(57) ABSTRACT

A marine autopilot system is disclosed that detects and manages potential collision scenarios using real-time sensor data and rule-based navigation logic. The system includes multiple onboard sensors, a processor, and a storage medium storing maritime navigation rules. The processor identifies hazards in a marine environment, classifies vessel encounter scenarios, and selects applicable navigation rules to generate recommended course or speed maneuvers. Recommended maneuvers are presented to a user through a graphical user interface, including integrated hazard maps, predicted object trajectories, and visual guidance indicating safe and unsafe headings. In some embodiments, the system presents user-selectable recommendations for collision avoidance and, upon user acknowledgment, autonomously executes corresponding steering or throttle commands. The system further supports sensor data fusion and prediction of future hazard positions to improve situational awareness and navigation safety, including two-dimensional and three-dimensional user interface displays illustrating encounter scenarios and avoidance maneuvers.

### RELATED APPLICATIONS

This application claims priority to U.S. provisional application 63/787,557 filed Apr. 11, 2025, the contents of which are hereby incorporated by reference herein.

### BACKGROUND

### 1. Field

The present disclosure relates generally to autonomous marine navigation systems.

### 2. Related Art

Conventional marine autopilot devices typically calculate a route and attempt to follow the calculated route without any real-time route updating during navigation.

### BRIEF DESCRIPTION OF THE DRAWING FIGURES

Embodiments of the invention are described in detail below with reference to the attached drawing figures, wherein:

FIG. 1 is a schematic view of a marine system in a marine environment, in accordance with embodiments of the present invention;

FIG. 2 is a block diagram of an exemplary marine autopilot system;

FIGS. 3A-3E are schematic views of the vessel equipped with various combinations of sensors;

FIG. 4A is an exemplary orthographic view of the marine environment generated from sensor data;

FIG. 4B is an exemplary perspective view of the marine environment generated from camera and sonar data;

FIG. 4C is an exemplary visualization of an underwater marine environment generated from sonar data;

FIG. 5 is an overhead view of the vessel depicting an exemplary virtual boundary and inner boundary defined around the vessel by the marine autopilot system;

FIG. 6 is an exemplary map displaying a planned path for the vessel;

FIGS. 7A-7C are schematic views depicting exemplary control trajectories for the vessel calculated in real-time;

FIG. 8 is a schematic view of an exemplary destination environment in the form of a marina, depicting a planned path for the vessel as well as future positions predicted by the marine autopilot system;

FIG. 9 is a schematic view of an exemplary weather system and a vessel route planned through the weather system by the marine autopilot system;

FIG. 10 is an exemplary view of a user interface for interaction with the marine autopilot system with selectable objects;

FIG. 11 is a flow chart illustrating exemplary operations for controlling a vessel through a marine environment using the marine autopilot system.

FIG. 12 is an exemplary map displaying hazards fused from various sensor sources;

FIG. 13 is an exemplary map displaying a proposed navigational path to avoid identified hazards and inviting user input;

FIGS. 14A-14D are exemplary views of a user interface depicting a crossing situation calculated and recommended by the marine autopilot system; and

FIG. 15 depicts an alternate exemplary user interface depicting the crossing situation.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, embodiments of the invention can include a variety of combinations and/or integrations of the embodiments described herein.

Generally, embodiments of the disclosure are directed to a marine autopilot system for controlling a vessel through a marine environment. In some embodiments, the marine autopilot system may utilize vessel dynamics and maps and charts of the marine environment to plan a path from a starting point to a destination. Under simple conditions the marine autopilot system may control a real-time trajectory by controlling the speed of the vessel as well as the direction of the vessel to follow the path. The marine autopilot system may utilize data from sensors detecting hazards such as, for example, other vessels, swimmers, buoys, weather conditions, and the like to modify the trajectory of the vessel to provide collision avoidance in real-time. The sensors may be combined to detect a four-dimensional (4D) view comprising above water and below water of the marine environment. Furthermore, the various sensor data may be collected and combined to generate a virtual map of the total marine environment comprising all features above and below water, and all moving objects including hazards within a local vicinity of the vessel. When the total virtual map is created a trajectory for the vessel to navigate the marine environment may be generated. Furthermore, the marine autopilot system may compensate for crosswinds and currents to minimize the error between the vessel trajectory and the planned path.

Embodiments facilitate users, especially inexperienced users, maneuvering a vessel under such adverse and otherwise challenging conditions as strong winds or currents, poor lighting, the presence of other boats, ships, or objects, poor fields of vision (especially for larger boats and ships), or poor maneuverability (especially for vessels without thrusters or forward motors). As used herein, “marine” shall refer to substantially any aquatic environment, including so-called “brown” or “blue” water environments, such as rivers, lakes, coastal areas, seas, and oceans.

In some embodiments operating in example marine environments, a vessel may include one or more motors, a control system, and a navigation system. The motors may be configured to drive and maneuver the vessel through the marine environment, and the control system may be configured to facilitate a user controlling the movement and orientation of the vessel, including controlling operation of the motors. The navigation system may be configured to inform the user with regard to operating the control system, including with regard to maneuvering the vessel for docking and to avoid objects in the marine environment.

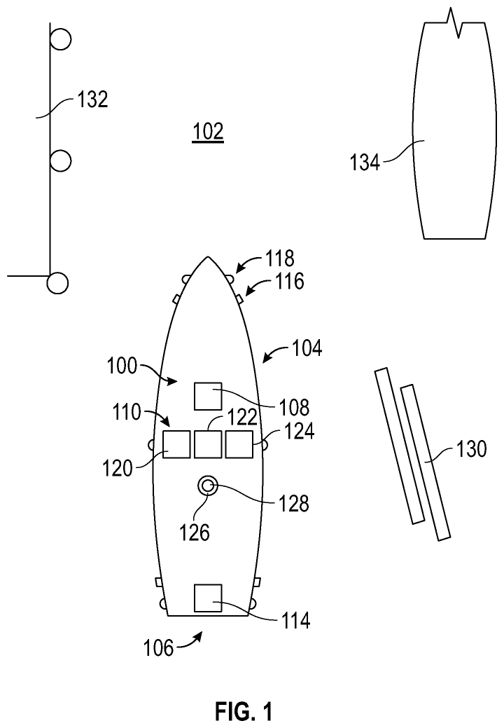

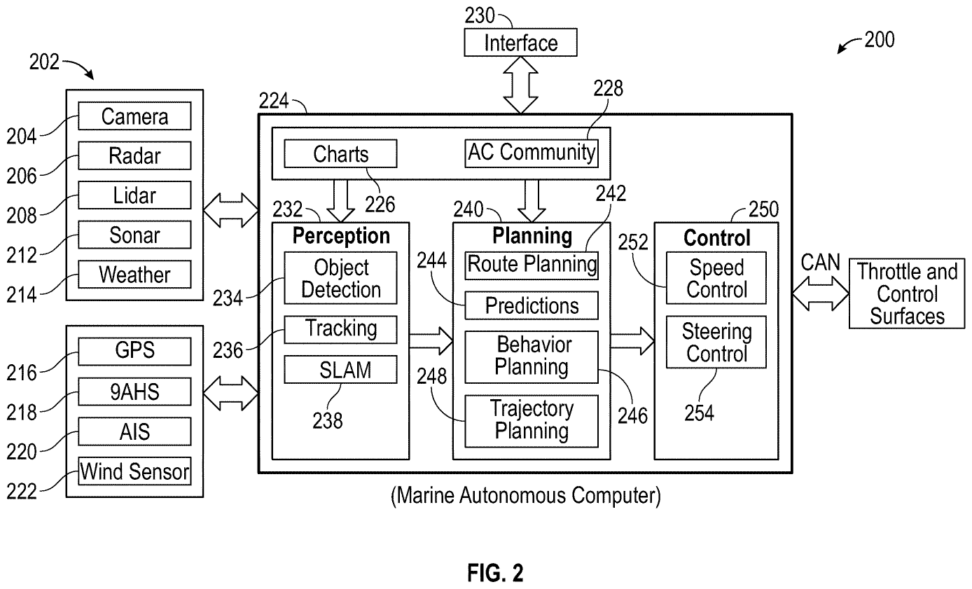

FIG. 1 depicts one example of a marine system 100 in marine environment 102. Although shown in the figures as a medium-sized boat, vessel 104 may be substantially any boat, ship, or other vehicle configured to travel in, on, or over water, including substantially any suitable size, type, and overall design, and which would benefit from marine system 100. In one implementation of marine system 100 and elements of an example operational marine environment, vessel 104 may include one or more motors 106, control system 108, and navigation system 110. Control system 108 and navigation system 110 may be integrated or provided as discrete components. Control system 108, navigation system 110, and sensors 202 (FIG. 2), are depicted as part of marine autopilot system 200 in FIG. 2.

One or more motors 106 may be configured to drive and maneuver vessel 104 through marine environment 102. In one implementation, one or more motors 106 may include primary motor 114 configured to provide a primary propulsive force for driving vessel 104, especially forwardly, through marine environment 102. In one implementation, primary motor 114 may be mounted to a rear portion (e.g., stern or transom) of vessel 104. Primary motor 114 may be configured with an actuator for rotating primary motor 114 in and out of the water by marine system 100. One or more motors 106 may further include secondary motors 116 configured to provide a secondary propulsive force for steering or otherwise maneuvering vessel 104 through marine environment 102. Secondary motors 116 may be used with primary motor 114 to enhance steering, or without primary motor 114 when maneuvering vessel 104 in situations that require relatively higher precision (e.g., navigating around other boats or other obstacles and/or in relatively shallow water). Secondary motors 116 may be used to steer vessel 104 and/or may be used to maintain vessel 104 at a substantially fixed position and/or orientation in the water. In various implementations, secondary motors 116 may be mounted to any suitable portion of vessel 104 (e.g., at or near a bow, stern, and/or starboard or port side of vessel 104) depending on the natures of secondary motors 116 and vessel 104. One or more motors 106 may employ substantially any suitable technology for accomplishing their stated functions, such as gasoline, diesel, and/or electric technologies. In embodiments, secondary motors 116 are configured as hull thrusters.

Control system 108 may be configured to facilitate a user controlling the movement and orientation of vessel 104. Depending on the design of vessel 104, this may include controlling the amount of thrust provided by and/or the orientation of some or all of one or more motors 106 and/or a position of a rudder or other control surfaces. Control system 108 may employ substantially any suitable technology for accomplishing its stated functions, such as various wired and/or wireless controls. Control system 108 may also comprise, in some embodiments, control system 250 (FIG. 2) as described below.

Navigation system 110 may be configured to inform the user with regard to how to operate control system 108, including with regard to maneuvering vessel 104 for navigating marine environment 102. Navigation system 110 may employ substantially any suitable technology for accomplishing its stated functions, such as various conventional navigational technologies. For example, by way of navigational technologies, navigation system 110 may include one or more sensors for detecting an orientation, change in orientation, direction, change in direction, position, and/or change in position of vessel 104. In some implementations, navigation system 110 may include a location determining component that is configured to detect a position measurement for vessel 104 (e.g., geographic coordinates of at least one reference point on vessel 104, such as a motor location, vessel center, bow location, stern location, etc.). In some implementations, the location determining component may be a global navigation satellite system (GNSS) receiver (e.g., a global positioning system (GPS) receiver, software defined (e.g., multi-protocol) receiver, or the like). In some implementations, navigation system 110 may be configured to receive a position measurement from another device, such as an external location determining component or from at least one of one or more motors 106. Other positioning-determining technologies may include a server in a server-based architecture, a ground-based infrastructure, one or more sensors (e.g., gyros or odometers), a Global Orbiting Navigation Satellite System (GLONASS), a Galileo navigation system, and the like.

In some implementations, navigation system 110 may include a magnetometer or GNSS heading sensor configured to detect an orientation measurement for vessel 104. For example, the magnetometer or GNSS heading sensor may be configured to detect a direction in which the bow of vessel 104 is pointed and/or a heading of vessel 104. In some implementations, navigation system 110 may be configured to receive an orientation measurement from another device, such as an external magnetometer, an external GNSS heading sensor, a location determining device, and/or one or more motors 106. In some implementations, navigation system 110 may include or be communicatively coupled with at least one inertial sensor (e.g., accelerometer and/or gyroscope) for detecting the orientation or change in orientation of vessel 104. For example, an inertial sensor may be used instead of or in addition to the magnetometer or GNSS heading sensor to detect the orientation.

Navigation system 110 may include a processing system communicatively coupled to the location and orientation determining components and configured to receive the position and orientation measurements and to control the integration and other processing and display of this and other navigational information and may perform other functions described herein. The processing system may be implemented in hardware, software, firmware, or a combination thereof, and may include any number of processors, controllers, microprocessors, microcontrollers, programmable logic controllers (PLCs), field-programmable gate arrays (FPGAs), application specific integrated circuits (ASICs), or any other component or components that are operable to perform, or assist in the performance of, the operations described herein. Various features provided by the processing system and, in turn, navigation system 110, may be implemented as software modules that are executable by the processing system to provide desired functionality.

The processing system may also be communicatively coupled to or include electronic memory for storing instructions or data. The memory may be a single component or may be a combination of components that provide the requisite storage functionality. The memory may include various types of volatile or non-volatile memory such as flash memory, optical discs, magnetic storage devices, SRAM, DRAM, or other memory devices capable of storing data and instructions. The processing systems are described in detail below in regard to FIG. 2.

In addition to the foregoing components, navigation system 110 may include, be operationally connected to, or otherwise make use of one or more cameras, such as one or more directional cameras 118 and/or overhead camera 128, computer 120, display device 122, and user interface 124. Each of computer 120, display device 122, and user interface 124 may be integrated within a common housing, such as in embodiments where navigation system 110 is a chartplotter. In other configurations, computer 120, display device 122, and/or user interface 124 may be configured as discrete elements that use wired or wireless communication techniques to interface with various components of marine system 100.

In addition to various navigation technologies such as mapping, routing, weather, radar, sonar, autopilot control, communications, and the like, embodiments of the navigation system may include, be operationally connected to, or otherwise make use of one or more directional cameras 118, overhead camera 128, computer 120, a display device 122, and user interface 124. Each directional camera may be mounted in a particular position on vessel 104 and oriented in a particular direction and configured to generate electronic images of marine environment 102 in the particular direction. Overhead camera 128 may be mounted on a mast or other elevated point 126 on vessel 104 and oriented downward and configured to generate images of vessel 104 and marine environment 102 surrounding the vessel 104. Computer 120 may be configured to receive and process the images from any or all of the one or more directional cameras 118 including overhead camera 128. Computer 120 may transform and stitch together the images from the one or more directional cameras 118 to create a virtual image and/or a virtual overhead image. Display device 122 may be a chartplotter or other electronic display configured to display the processed images, and user interface 124 may be configured to allow the user to provide input regarding operation of some or all the other components of navigation system 110.

In various implementations, navigation system 110 may be configured to provide any one or more of the following features to inform the user. An object identification feature may detect and identify objects in the images and may visually highlight the detected and identified objects in displayed images. A distance marker feature may add markers indicating distance in the displayed images. A collision prediction feature may determine the relative speeds and directions of movement of the objects and vessel 104 and communicate a warning when the relative speed and direction of movement indicates that a particular object and the vessel will collide. An automatic camera selection feature may determine a direction of movement of vessel 104 and automatically display the image generated by one or more directional cameras 118 oriented in the determined direction of movement. A virtual boundary feature may define a virtual boundary and add the virtual boundary to a displayed image at a specified distance around vessel 104 and may determine and communicate a warning when a particular object crosses the virtual boundary. Relatedly, the system may automatically display the image from one or more directional cameras 118 oriented in the direction of the particular object. An image combining feature may combine multiple images from different cameras to create a combined image. A virtual overhead image may be created by transforming and combining multiple images from different cameras. A track display feature may determine a velocity vector and a projected track and may record a track history of the vessel and may add some or all of this information to a displayed image. All overlays (i.e., object highlights, virtual boundaries, distance markers) on individual camera images, combined images and virtual overhead images may be synchronized between the different views to have the same overlays simultaneously shown on a display or multiple displays from different points of view. In some embodiments, navigation system 110 may detect and classify exemplary hazards such as dock 132, ship 134, and breakers 130, and control system 108 may control vessel 104 to avoid the hazards. The object detection, distance markers, virtual boundaries, and navigation and control of vessel 104 is discussed in detail below.

FIG. 2 depicts an exemplary embodiment of marine autopilot system 200. In some embodiments, sensors 202 may obtain data indicative of marine environment 102 and the orientation of vessel 104. Sensors 202 may comprise camera system 204, radar system 206, LIDAR system 208, sonar system 212, wind sensor (e.g., anemometer) 222, GPS 216, inertial measurement unit (IMU) 218 (e.g., a 9 degree-of-freedom attitude and heading system (9AHS or 9-DOF AHRS)), weather detection system 214, AIS connections 220, and any other sensor that may be useful in embodiments described herein. Sensor data may be obtained by marine autopilot computer 224, which may be or otherwise comprise computer 120, for navigation and control of vessel 104.

In some embodiments, camera system 204 may comprise the one or more directional camera 118 and may be mounted in a particular position on vessel 104 and oriented in a particular direction and configured to generate electronic images of marine environment 102 in the direction that each of the one or more directional camera 118 is pointing as described above. In some implementations, one or more directional cameras 118 may be sufficient in their number and orientations to provide up to three hundred sixty degrees of image coverage of marine environment 102 around vessel 104. Furthermore, overhead camera 128 may be mounted on a mast or other elevated point 126 on vessel 104 and oriented downward and configured to generate images of vessel 104 and marine environment 102 surrounding vessel 104. One or more directional cameras 118 and overhead cameras 128 may employ substantially any suitable technology to generate image data of substantially any suitable nature, such as optical, radar, LIDAR, and/or infrared. Radar system 206, LIDAR system 208, sonar system 212, and weather detection system 214 are discussed in more detail in embodiments below.

Marine autopilot system 200 may include an image combining feature (module) as part of perception system 232, which may be configured to combine multiple images from sensors 202 to create a single combined image, images, or virtual environment for display. In one implementation, images from several or all of sensors 202 may be stitched together or otherwise combined and transformed to provide a three hundred sixty degree “overhead” view of vessel 104 and its surroundings. In various implementations, the overhead view may be individually displayed, the overhead view may be simultaneously displayed with multiple images from multiple cameras, and/or the overhead view may be selectable for individual or simultaneous display with images from selected cameras. The user may be allowed to enable and disable this feature or any particular aspect or implementation of this feature as desired or needed.

Furthermore, perception system 232 may receive chart data from charts 226. The chart data may comprise geographic features of marine environment 102 for generating navigational plans. Furthermore, perception system 232 comprises tracking system 236 and Simultaneous Localization and Mapping (SLAM) 238 for tracking vessel 104 as well as other objects in marine environment 102 and simulating marine environment 102 with all objects simultaneously.

Marine autopilot system 200 may stitch together all available data to generate a virtual three-dimensional marine environment. The chart data may be used to generate the features of the marine environment 102 such as water depth, GPS locations of buoys, shoreline, docks, and the like. An Automatic Identification System (AIS) transceiver may be used to generate and track locations of other vessels. Sensors 202 may also be used to generate locations and classifications of objects on the water and under the water as described herein. The virtual map may be generated to plan and simulate a path through marine environment 102 by vessel 104.

Marine autopilot system 200 may include tracking system 236 which may be configured to determine a velocity vector and/or a projected trajectory and/or to record a trajectory history of vessel 104 and to add some or all information to a displayed image and/or SLAM. Marine autopilot system 200 may be further configured to similarly display a desired track and may simultaneously display the desired and projected tracks. The user may be allowed to enable and disable visual tracking or any particular aspect or implementation as desired or needed for display.

Interface 230 comprises at least one display, microphone, speakers, and various inputs that the user may interact with to control vessel 104 and interact with marine system 100. Interface 230 may comprise display device 122 and user interface 124. Interface 230 may be communicatively coupled with the computer 120 and may be configured to display the processed images. In various implementations, a single image from a single camera may be individually displayed, multiple images from multiple cameras may be simultaneously displayed, and/or images from selected cameras may be displayed individually or simultaneously. Further, as discussed below, multiple images from different cameras may be combined into a single image and displayed. Display device 122 may employ substantially any suitable technology for accomplishing its stated functions, such as liquid crystal display (LCD), light-emitting diode (LED) display, light-emitting polymer (LEP) display, thin film transistor (TFT) display, gas plasma display, or any other type of display. Display device 122 may be backlit such that it may be viewed in the dark or other low-light environments. Display device 122 may be of any size and/or aspect ratio. In one implementation, display device 122 may include touchscreen technology, such as resistive, capacitive, or infrared touchscreen technologies, or any combination thereof. In one implementation, display device 122 may be a chartplotter which integrates and displays position data with electronic navigational charts. In some embodiments, interface 230 may be user interface 124.

Interface 230 may be configured to allow the user to provide input regarding operation of some or all of the other components of navigation system 110. Interface 230 may employ substantially and suitable technology for accomplishing its stated functions, such as electromechanical input devices (e.g., buttons, switches, toggles, trackballs, and the like), touch-sensitive input devices (e.g., touchpads, touch panels, trackpads, and the like), pressure-sensitive input devices (e.g., force sensors or force-sensitive touchpads, touch panels, trackpads, buttons, switches, toggles, trackballs, and the like), audio input devices (e.g., microphones), cameras (e.g., for detecting user gestures or for face/object recognition), or a combination thereof. In configurations, interface 230 may be integrated with the display, such as in embodiments where the display is configured as a chartplotter and interface 230 is configured to control the operation of the chartplotter through buttons, touch sensors, and/or other controls.

Marine autopilot system 200 further comprises community data 228 providing updated real-time data in marine environment 102. The community data may come directly from a central communication device transmitting location and navigation data for marine environment 102 or may be obtained from each individual vessel within marine environment 102. Community data 228 may comprise the location velocity of vessels in a designated area such as marine environment 102. This data may be obtained in any format readable by marine autopilot system 200 and may be integrated into SLAM 238 to provide a virtual map of marine environment 102.

Planning system 240 may obtain data from interface 230, community data 228, and from perception system 232 to plan paths between locations in marine environment 102. Planning system 240 may comprise route planning module 242. Route planning module 242, in some embodiments, determines an optimized route between the two locations based on the information obtained from interface 230, community data 228, and perception system 232. The determined route may comprise a path from a first location to a second location in marine environment 102. The path may avoid all known obstacles and optimize the path based on time of travel, energy savings, safest route, user comfort, or any combination thereof, or the like. Furthermore, various paths may be provided to the user and the user may select a path. The user may also be given levels of comfort for each path. Marine autopilot system 200 may learn a comfort level for each user based on the paths that each user selects and enjoys the most.

The planned path may be a baseline path that may be adjusted intermittently based on current data comprising updated information from community data 228, sensors 202, weather forecasts, and the like. Specific examples of path planning based on marine environment 102 and hazards is described in detail below.

Prediction module 244 may estimate potential hazards and conditions that may be encountered during the trip. Sensors 202 may detect obstacles such as jet skis, boats, rocks, tree branches, swimmers, buoys, underwater shipwrecks, seaplanes, and the like, in the water. The location and direction of travel of the hazards may be determined and a hazard level may be associated with each object. The location, direction of travel, and hazard level may be stored along with a classification for each hazard. The hazard level and object detection and classification are discussed in more detail below. Various status information for hazards may be ascertained by module 244, such as, for instance, the location, orientation, speed, attitude, type, and duration of a hazard. Module 244 may both identify the current status of various hazards but additionally predict the future status of hazards. For example, for a moving hazard, prediction module 244 may predict the hazard's future path, location, orientation, speed, and the like.

Behavior planning module 246 may estimate potential control of vessel 104 that may be required to navigate the preferred route through the predicted conditions of marine environment 102 based on the dynamic model of vessel 104. Behavior planning module 246 may estimate maneuvers for vessel 104 based on vessel dynamics including vessel capabilities for maneuverability as well as the classification and maneuverability of other objects. Furthermore, standard marine operating procedures may be stored and used to determine path planning and prediction. For example, vessel dynamics may be taken into account when vessel 104 comes into a local area of another vessel. Furthermore, it may be determined that the other vessel has low maneuverability such as a sailboat or a tanker. Therefore, the other vessel may have the right-of-way and vessel 104 may be instructed by marine autopilot system 200 to turn a particular direction to avoid coming too close to the other vessel.

Trajectory planning module 248 may determine the projected trajectory or trajectory segments used to control vessel 104 along or near the predicted path based on the determined obstacles and the behavior planning module output. Continuing with the example above, marine autopilot system 200 may calculate a trajectory to avoid the other vessel and bring vessel 104 back to the designated path after the other vessel has passed. The trajectory may be based on the maneuvering capabilities of vessel 104 and, in some embodiments, of the other vessel. In some configurations, the trajectory planning module 248 may calculate a plurality of trajectories for presentation to the user for selection and/or analysis.

Control system 250 may utilize the output from planning system 240 to control vessel 104 along the trajectory. Control system 250 may completely autonomously control vessel 104 or the user may have some input in a hybrid control system. For example, marine autopilot system 200 may control direction with steering control module 254 while the user controls the throttle, or marine autopilot system 200 may control the throttle with speed control module 252 while the user controls the direction. Either way, planning system 240 may provide the guidance to the controller and the controller may translate the guidance to command the various motors and control surfaces of vessel 104 to follow the path and avoid hazards.

Any linear, nonlinear, and adaptive controllers may be used to control the various control surfaces and throttles to navigate the predicted trajectory. Furthermore, vessel state estimation and estimates of wind dynamics, sea dynamics, and any other external forces may be estimated using state estimation algorithms such as extended Kalman filters and the like.

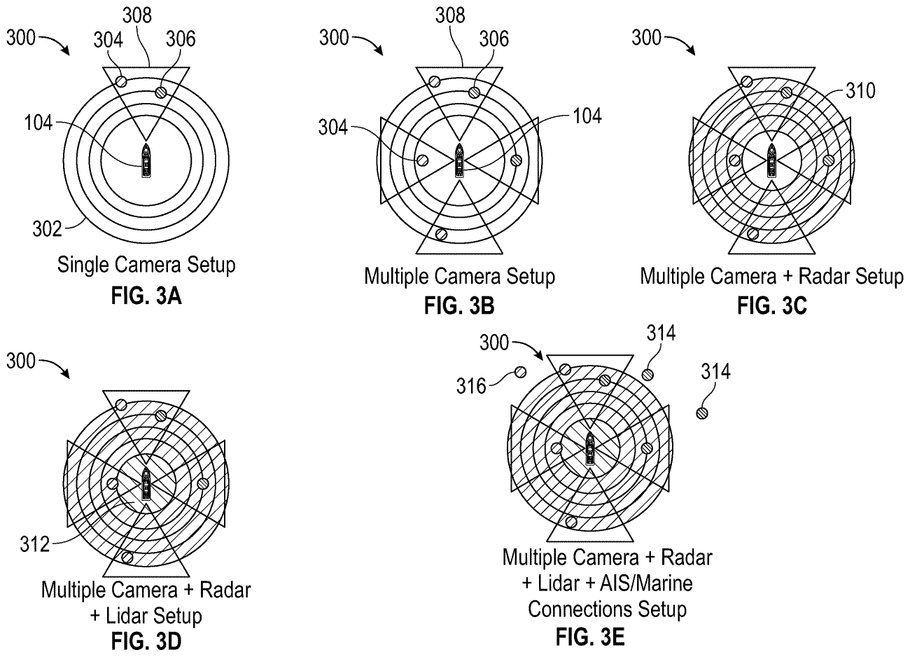

A variety of sensors 202 may be used to detect objects in marine environment 102. FIG. 3A-3E depict various levels of environment sensing that may be achieved by some of the variety of sensors 202 associated with marine autopilot system 200 as depicted by the range and sensor icons 300. FIG. 3A depicts vessel 104 with exemplary range markers 302. As depicted, vessel 104 comprises a single camera pointing forward. Camera view 308 illustrates the view from the camera including a green target 304 and a red target 306 (colors depicted by the illustrated texture). The targets may be rocks, swimmers, boats, ice, buoys, tree branches, debris, or any object that may be detected by the camera. The green target 304 may be moving away from vessel 104 and may not be in any danger of collision, which is why the target is green. The red target 306 may be in danger of colliding with vessel 104 and is therefore indicated by the red color. In some embodiments, the camera may face forward or may rotate to various directions automatically or controlled by the user or steering. In some embodiments, a plurality of cameras may view marine environment 102 as depicted in FIG. 3B. As such, full or near full coverage of marine environment 102 may be captured by camera system 204 up to a range given by the quality of cameras used. The images from the plurality of cameras may be stitched together to generate a near full 360 °marine environment model.

FIG. 3C depicts camera system 204 combined with radar system 206. Radar system 206 may detect objects a full 360 °around vessel 104 as shown by radar texture 310. Furthermore, utilizing radar system 206, may allow detection of smaller objects that may not be quickly detected and classified by camera system 204. Radar system 206 may also detect objects in low visibility when there is fog on the water. When visibility is reduced, the user, and marine autopilot system 200, may rely on radar system 206 to detect hazards that need to be avoided. This provides marine system 100 the ability to operate at night and in low-visibility conditions.

FIG. 3D depicts camera system 204 and radar system 206 combined with LIDAR system 208. LIDAR system 208 may comprise both short-and long-range LIDAR and may image detailed geometry of obstacles within a LIDAR range exemplified by LIDAR range 312. This may be especially useful when navigating close quarters such as in a marina and when docking. Marine autopilot system 200 may navigate vessel 104 to dock in an unknown location based on the detailed geometry obtained by the various sensors. LIDAR system 208 may provide an extremely detailed virtual image of the environment including precise distances between vessel 104 and obstacles such as sides of a dock, that marine autopilot system 200 may dock vessel 104 and/or navigate tight waterways such as, for example, canals in Vienna or Florida.

FIG. 3E depicts camera system 204, radar system 206, LIDAR system 208, combined with AIS connections 220. Communicating with the local marine network further provides location and direction information for boats that may be out of range of detection by sensors 202 onboard vessel 104 as illustrated by outside hazards 314 and outside object 316. Furthermore, communication with the transponders of other ships by AIS connections 220 may provide an additional location sensor for tracking directly by marine autopilot system 200 for simulation of marine environment 102.

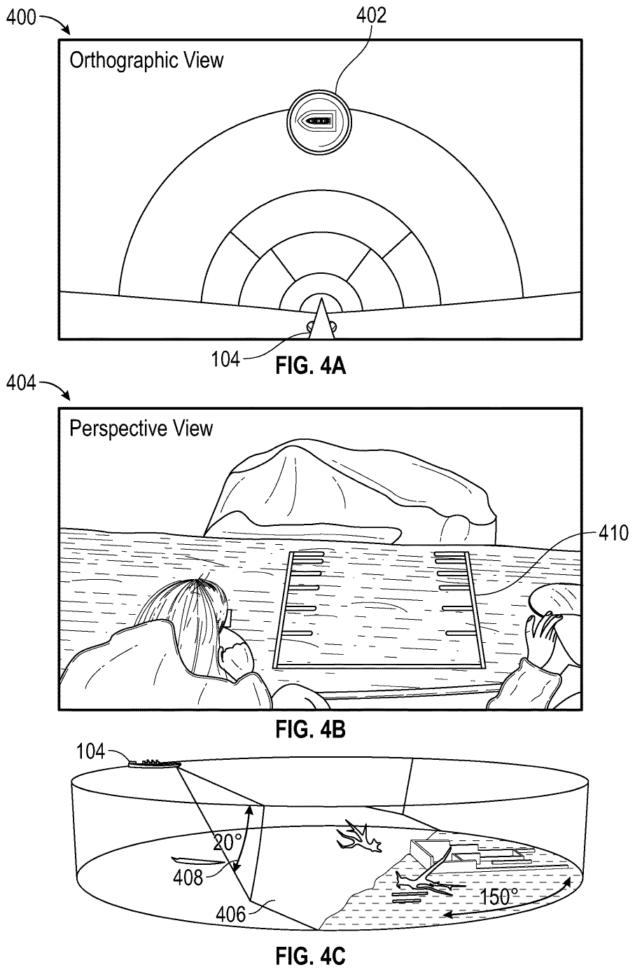

FIG. 4A-4C depict exemplary visualizations provided by camera system 204 and sonar system 212. In some embodiments, sensors 202 may provide information related to obstacles, or objects, on or in the water or air surrounding vessel 104. The objects may have specific geometries that may be detected by sensors 202 such that the objects may be classified by an object recognition system, which may be included in object detection system 234. For example, the object recognition system may comprise neural networks trained on objects expected to be found in marine environment 102. For example, visual object detection and determination may be performed on still images. The objects in the images may be determined by convolution neural networks trained on images of boats, ships, sailboats, jet skis, paddle boarders, swimmers, buoys, and the like. Accordingly, the objects may be classified and stored along with estimated dynamic models of the objects such that maneuverability characteristics of the objects may provide a hazard level determination. The hazard level determination may be indicative of boundaries of a set of objects as discussed in more detail below. Furthermore, the visual characteristics may be combined with any other data detected by sensors 202 to classify the objects. For example, acoustic sensors may provide a sound classification such as boat motors, animal noises, people talking, people or animals swimming, and the like. Comparing the object classification with the sound classification may further provide an increased probability for object detection, classification, and hazard classification.

FIG. 4A depicts one example of an orthographic view 400 that may be generated from data obtained from camera system 204, radar system 206, LIDAR system 208, sonar system 212, AIS connections 220, or any other types of sensors 202 or any other data source. The location, geometry, and velocity of the object may be determined and caused for display. As shown, the object is another boat 402. Other boat 402 may be detected by sensors 202 and the orthographic view 400 may be provided for the user (e.g., boat Captain) to visualize a distance to the other boat 402 as well as motion and time to impact if the other boat is a hazard. Camera system 204 may also be used to show perspective view 404 depicted in FIG. 4B. As shown in FIG. 4B, the object is an iceberg. Perspective view 404 may be a direct live view from a camera of camera system 204 pointed toward the front of vessel 104 or in any direction. Furthermore, sonar system 212 may be used to detect the portion of the iceberg that is underwater.

FIG. 4C depicts an exemplary underwater marine environment 406. Sonar system 212 may detect underwater objects at a specific angle 408 such that objects below, to the sides, and in front of vessel 104 are detected. The sonar data may be collected and analyzed to classify the objects under the water based on characteristic sonar cross sections. The classifications may be automatically annotated for display by a such as display device 122. Furthermore, the sonar data may be indicative of the depth of the water below and in front of vessel 104. As such, vessel 104 may be controlled to slow down and stop when the water depth becomes too shallow.

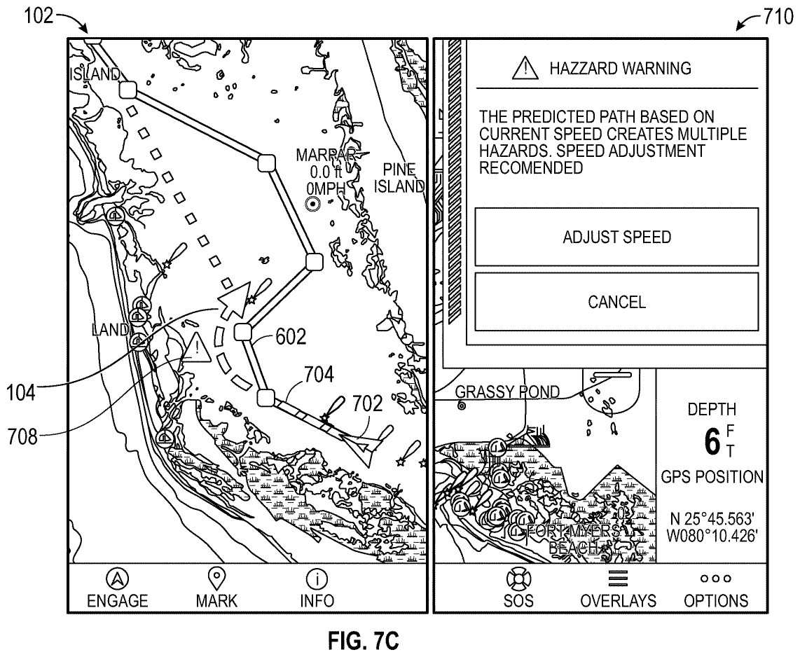

In various implementations, the navigation system 110 may be configured to provide any one or more of the following features to inform the user with regard to operating the control system 108. Marine autopilot system 200 may include an object identification feature as described above, which may be configured to detect and identify objects in the images. Objects may include any relevant objects or categories of objects such as docks, shores, rocks, buoys, other boats, and debris (e.g., logs). The object identification features may be further configured to detect and identify the water itself (or non-water) in the images in order to better distinguish between the water, non-water, and/or objects in or around the water. In some implementations, marine autopilot system 200 may employ an artificial intelligence module, which may be part of perception system 232, in the form of, e.g., machine learning, computer vision, or neural networks trained with water, non-water objects, and boats in order to learn to reliably identify and distinguish between the objects and the water. In alternative implementations, marine autopilot system 200 may specifically identify individual objects by type or may merely distinguish between objects and water. In some embodiments, in which the object is a dock (FIG. 8), the object recognition feature may include providing a detailed docking view for the user. In such configurations, the marine autopilot system 200 may be calibrated along the dock of interest detailing the sides and the end of the dock.

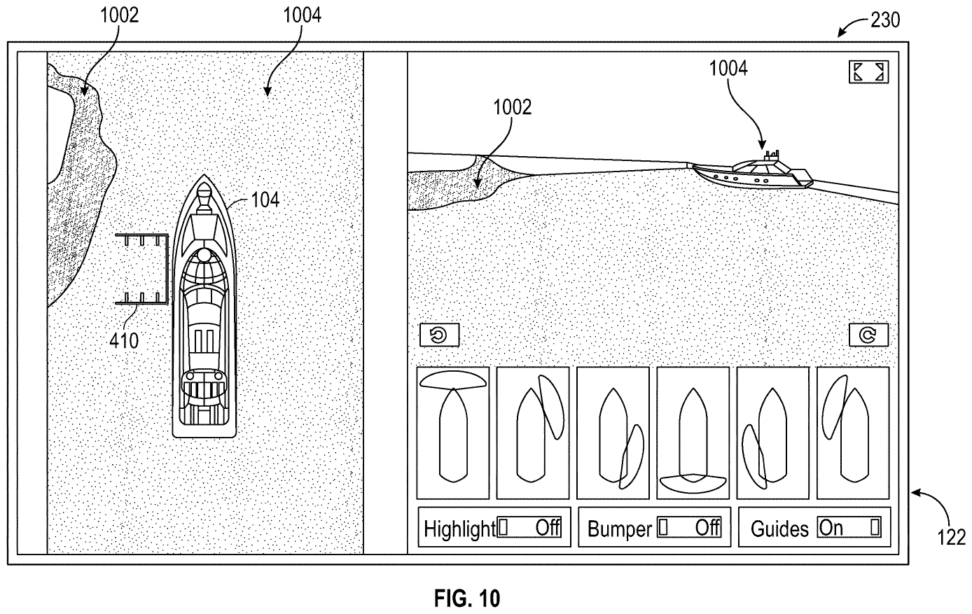

Marine autopilot system 200 may be further configured to visually highlight the objects (FIG. 10) in displayed images to facilitate awareness by the user. For example, water may be highlighted bright blue or another color, non-water may be highlighted another color, and/or non-water objects may be highlighted yellow or another color. In some implementations, the user may be allowed to select the highlight colors, what objects are highlighted, whether and how water and non-water are highlighted, and how objects are highlighted. Object detection and highlighting may be performed on a pixel-by-pixel basis to allow clear differentiation between objects and water. In some embodiments, the display device 122 may display a first particular image, for example a virtual overhead image generated by combining images from one or more directional cameras 118, in which objects and water may be highlighted, and may simultaneously display a second particular image from a user-selected or automatically selected a camera of one or more directional cameras 118 in which objects and/or water may or may not be highlighted. The user may be allowed to enable and disable this feature or any particular aspect or implementation of this feature as desired or needed.

As mentioned, in some implementations, data from an image may be processed using an artificial intelligence computer vision module to identify one or more objects in the image, vessel 104 itself, and the water. The computer vision technology may include a machine learning model, such as a neural network, trained to perform object detection and/or image segmentation to identify the location of one or more objects in the image data received from the one or more cameras from camera system 204. Object detection may involve generating bounding boxes around objects. Image segmentation may provide greater granularity by dividing the image into segments, with each segment containing pixels that have similar attributes. In semantic segmentation every pixel is assigned to a class, and every pixel of the same class is represented as a single instance with a single color, while in instance segmentation different objects of the same class are represented as different instances with different colors.

One example technique for segmenting different objects is to use region-based segmentation in which pixels falling above or below a threshold are classified differently. With a global threshold, the image is divided into object and background by a single threshold value, while with a local threshold, the image is divided into multiple objects and background by multiple thresholds. Another example technique is to use edge detection segmentation which uses the discontinuous local features in any image to detect edges and thereby define the boundary of the object. Another example technique is to use cluster-based segmentation in which the pixels of the image are divided into homogeneous clusters. Another example technique, referred to as Mask region-based convolutional neural network (R-CNN), provides a class, bounding box coordinates, and a mask for each object in the image. These or other techniques, or combinations thereof, may be used by marine autopilot system 200 to identify objects in the images. Such a configuration allows marine autopilot system 200 to be trained to identify desired object types and provide specific feedback for each identified object type. In embodiments, the user of marine autopilot system 200 may identify and label objects displayed on display device 122 using interface 230 to update or retrain the computer vision module. For example, if marine autopilot system 200 is not trained to identify an object that the user commonly encounters, the user may retrain marine autopilot system 200 to automatically identify the object in the future by highlighting the object using interface 230.

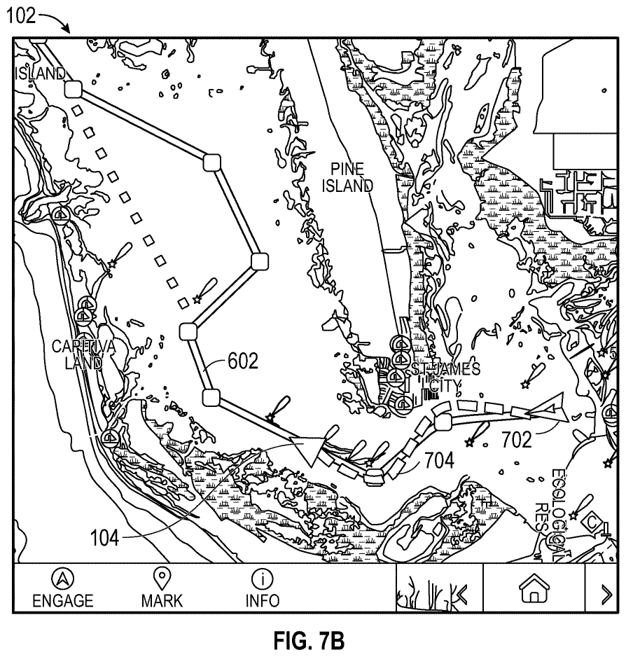

Furthermore, marine autopilot system 200 may include a collision prediction feature as part of prediction module 244, which may be configured to determine relative speeds and directions of movement of other vessels or other objects and vessel 104. Further, warnings may be communicated when the relative speed and direction of movement indicates that a particular object (e.g., iceberg FIG. 4B, or other vessel FIG. 4A) and vessel 104 will collide. Relatedly, the marine autopilot system 200 may be configured to automatically display the image from one or more directional cameras 118 oriented in the direction of the particular object. In one implementation, a pop-up bug may appear in a portion of a displayed image related to the threat (FIG. 7C). The pop-up bug may be selectable by the user to cause to be displayed additional information about the object (e.g., identification, direction, velocity). The user may be allowed to enable and disable the pop-up bug feature or any particular aspect or implementation of this feature as desired or needed.

The marine autopilot system 200 may include an automatic camera selection feature (module) as part of camera system 204 which may be configured to automatically select and display one or more images generated by one or more directional cameras 118 which are particularly relevant based on, e.g., the vessel's drive status or input or other considerations. For example, the marine autopilot system 200 may be configured to determine an orientation and/or a direction of movement of vessel 104 and automatically display the image generated by one or more directional cameras 118 oriented in the determined direction of movement. In another example, movement rearward or aft may cause the marine autopilot system 200 to automatically display an image generated by one or more directional cameras 118 oriented rearward. The direction of movement may be determined using, e.g., GPS, IMU, or other position-or motion-sensing technologies which may be part of navigation system 110. The user may be allowed to enable and disable this feature or any particular aspect or implementation of this feature as desired or needed. In some configurations, computer 120 may detect objects and/or other features in images from any particular camera and alert the marine autopilot system 200 to automatically display images from the particular camera based on detected objects. For example, if the user is viewing images from a first camera on display device 122, an object is detected on a second camera not currently being viewed by the user, the marine autopilot system 200 may transition to display of the second camera feed to ensure that the user is aware of the detected object.

Any sensors 202 may obtain data indicative of objects in marine environment 102. The sensor data may be analyzed by any algorithms to compare to known, geometries, sounds, and environmental effects from the objects to classify and display the objects as described above. The sensor data and the object classifications may be stored and simulated in SLAM 238. Therefore, any data collected by sensors 202 may be used to simulate marine environment 102 and for planning system 240 and control system 250.

Continuing with FIG. 4B (also shown in FIG. 10), marine autopilot system 200 may include a distance marker feature (module) which may be configured to overlay onto (or otherwise incorporate into displayed images) distance markers 410 providing scale and indicating distance to facilitate the user determining distances to objects. Lines and/or tick marks may communicate the dimensions and distances from vessel 104 of other docks, other vessels, and other objects. The lines and/or tick marks may represent dimensions and distances of approximately between one meter and five meters in increments of one meter. In some implementations, the display device 122 may display a first particular image from overhead camera 128, and/or a virtual overhead image generated by combining or otherwise stitching together images from camera system 204, in which the distance markers 410 are added, and may simultaneously display a second particular image from a user-selected or automatically selected camera of one or more directional cameras 118 in which the distance markers 410 may or may not be added. The user may be allowed to enable and disable this feature or any particular aspect or implementation of this feature as desired or needed.

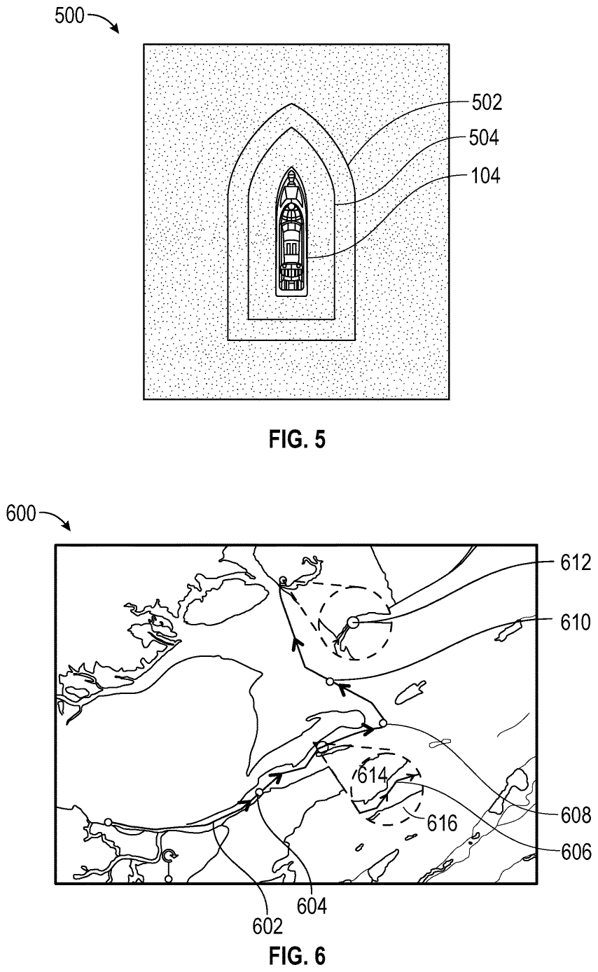

FIG. 5 depicts one example of a virtual boundary 502 around vessel 104 in overhead view 500. Marine autopilot system 200 may include a virtual boundary module, which may be included with perception system 232 and planning system 240. Virtual boundary module may be configured to define virtual boundary 502 and overlay or otherwise incorporate virtual boundary 502 into a displayed image at a specified distance around vessel 104. Furthermore, marine autopilot system 200 may be further configured to determine and communicate a warning when an object crosses virtual boundary 502. Accordingly, marine autopilot system 200 may be configured to automatically display the image from the direction from camera system 204 oriented in the direction of the object.

In some implementations, as shown in FIG. 5, marine system 100 may be further configured to determine and display a second or more set of one or more boundaries, which are located at various distances from vessel 104 (e.g., virtual boundary 502 and inner boundary 504). Distances between vessel 104 and each boundary may be adjustable by the user or determined based on the type and maneuverability of vessel 104. In some implementations in which there are at least two sets of boundaries, one or more of the boundaries may be configured to ignore object detection, while one or more of the boundaries may be configured to respond to object detection. In some implementations, each boundary may provide passive visual indicators of distances to various objects. In other implementations, each boundary may actively change color entirely or locally to indicate an object breaking or nearing the boundary. For example, virtual boundary 502 may turn yellow when an object crosses and inner boundary 504 may turn red when an object crosses. In yet other implementations, the marine system 100 may be configured to automatically communicate a visual and/or audible warning or other alert to the user when an object breaks a boundary, and, possibly, the size of, classification of the object (e.g., trash, log, rock, animal), and/or distance to the object.

The user may be allowed to enable and disable the boundary feature or any particular aspect or implementation of the boundary feature as desired or needed. In some implementations, if the user has not enabled the boundary feature, marine system 100 may be configured to automatically enable the boundary feature when marine autopilot system 200 detects an object at or within a user-specified distance from vessel 104.

In some embodiments, virtual boundary 502 is automatically enabled and defined by the type and maneuverability of vessel 104 and type and maneuverability of a detected object. For example, vessel 104 may be a large cruise ship or a freight liner that is not capable of quick maneuvers. As such, virtual boundary 502 may be at a distance that allows vessel 104 to easily identify the object and maneuver before collision with the object. Furthermore, the object may be a second vessel. The distance to virtual boundary 502 may be adjusted based on the classification of the second vessel and the stored indicator of maneuverability of the second vessel. For example, the second vessel may be a sailboat and may not be very maneuverable, as such the distance between vessel 104 and virtual boundary 502 may be relatively large. Furthermore, a sailboat virtual boundary may be added to the sailboat image to decrease the allowable range between vessel 104 and the sailboat. When virtual boundary 502 crosses the sailboat virtual boundary, the user is notified and marine autopilot system 200 may command object avoidance.

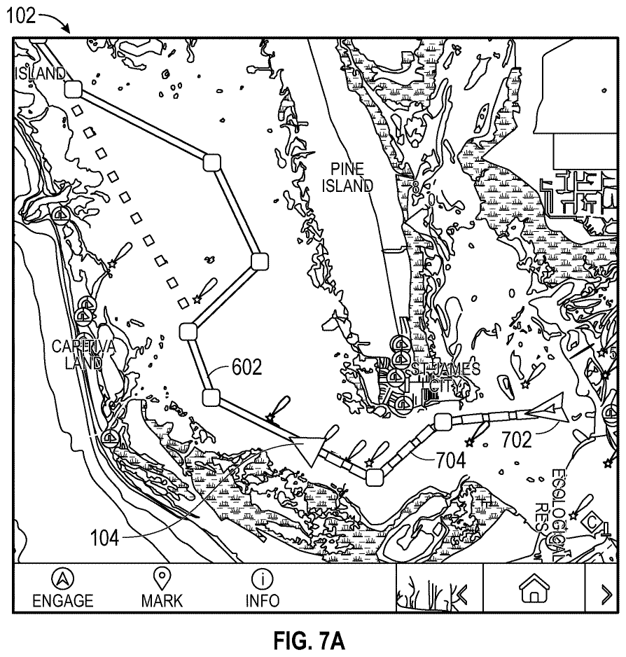

FIG. 6 depicts an exemplary map 600 displaying path 602 showing various locations for adjusted planning based on geometry and marine rules. In some embodiments, at step 604, vessel 104 may be in a speed limit zone. Marine autopilot system 200 may recognize buoys with speed limit signs and control vessel 104 to maintain the speed limit. Furthermore, in some embodiments, there may be proximity sensors detecting speed limit data transmitted by short range transmitters. In some embodiments, geofences may be established and detectable by marine autopilot system 200. In some embodiments, speed limits may be charted such that when vessel 104 is within a designated area, marine autopilot system 200 determines the speed limit from the marine charts and controls vessel 104 to maintain the designated speed limit associated with the area.

At step 606, marine autopilot system 200 may detect tight quarters by sensors 202. As shown, path 602 for vessel 104 may travel a narrow corridor between shore 614 and a small island 616. Similarly, the tight quarters may be charted so that marine autopilot system 200 may be aware of the potential for danger and reduce the speed of vessel 104. Marine autopilot system 200 may control the speed and direction of vessel 104 based on the tight quarters. Marine autopilot system 200 may slow vessel 104 to navigate the tight quarters based on the maneuverability of vessel 104. For example, vessel 104 may be a larger vessel such as a cruise ship navigating a port. Marine autopilot system 200 may reduce the speed of the cruise ship such that the cruise ship may easily maneuver through the port to open seas. The cruise ship may be driven by the captain or by marine autopilot system 200.

At step 608, vessel 104 navigates a sharp turn. As path 602 is known, marine autopilot system 200 may plan a trajectory including speed to navigate path 602. Marine autopilot system 200 may slow the speed of vessel 104 by controlling the throttle in anticipation of the turn. A distance prior to the turn may be set to slow the speed based on the sharpness of the turn. In some embodiments, the speed reduction and the distance prior to the turn may be calculated based on and proportional to the cruise speed of vessel 104 and/or the angle of the turn. Turn dynamics are discussed in detail below in relation to FIGS. 7A-7C.

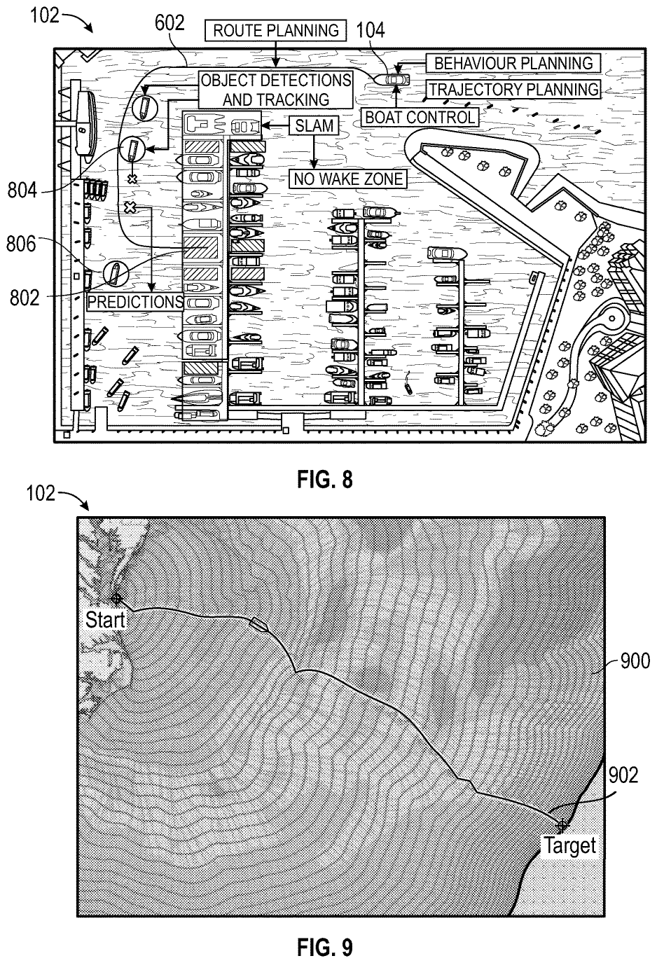

At step 610, marine autopilot system 200 may adapt the speed of vessel 104 based on the weather conditions. The speed and direction of vessel 104 may be automatically adapted to the wind direction and current. Motors, such as secondary motors 116 may be controlled to compensate for the current and wind, while on sailboats instructions for tack/jibes may be displayed for the user or automatically operated by marine autopilot system 200. These concepts are discussed in more detail below and displayed in FIG. 9.

At step 612, marine autopilot system 200 may change the speed and direction of vessel 104 to navigate the many obstacles that may be present at a destination. As vessel 104 approaches the destination environment, which in this embodiment is a busy marina, vessel 104 may slow to maneuver the various narrow surroundings and the various objects that may be in path 602 or close to path 602 planned by marine autopilot system 200. Charts and maps may be used to determine navigation of the stationary obstacles such as piers, breakers, docks, and the like. In some embodiments, LIDAR system 208 may be used to scan the docks and identify an empty dock where vessel 104 may stop. Furthermore, a detailed map of the dock may be made and continually updated so that marine autopilot system 200 may control vessel 104 into the dock. Furthermore, sonar system 212 may be used to determine the underwater depth at the dock to determine that there is enough depth for vessel 104. A detailed destination environment is discussed below and illustrated in FIG. 8.

FIGS. 7A-7C depict control trajectories for vessel 104 based on the velocity of vessel 104. As described above, marine autopilot system 200 may provide path planning to provide guidance trajectories for enhanced situational awareness. The guidance may be based on charts, community data (AIS), current boat speed, speed zones, hazards, and moving targets. As depicted in FIG. 7A, path 602 is planned by planning system 240 prior to navigation by vessel 104 and after receiving a destination location. Path 602 may be planned from a starting position 702 to the destination (not shown). Local trajectory 704 may be determined in real-time by following path 602 and including the current marine environment data that includes community data, vessel speed, speed zones, detected hazards, and detected moving targets, which may also be described herein as hazards or objects. FIG. 7A depicts precise path following where local trajectory 704 calculation is along path 602 and the vessel 104 follows the trajectory precisely. Here, the speed of vessel 104 is adapted such that each turn may be completed with vessel 104 staying within a threshold distance error of the path 602 as projected along the local trajectory 704 as calculated. As described above, the speed of vessel 104 may be reduced based on the angle of the turn such that vessel 104 is able to maneuver the turn while staying close to the planned path.

FIG. 7B depicts an exemplary trajectory of vessel 104 overshooting a turn because the speed of vessel 104 is too great. In this situation, the speed may be controlled by the user while the navigation is controlled by marine autopilot system 200. As such, the user may control the speed to be faster than required by vessel 104 to make the turn and remain on path 602. Marine autopilot system 200 may provide a warning to the user to reduce the speed and provide a maximum speed or a range of speeds necessary to remain within a distance of path 602. When the speed is too great, a slight overshoot and subsequent path correction by marine autopilot system 200 may result.

FIG. 7C depicts a scenario where the speed is too great entering the designated turn and hazard 708 follows when vessel 104 overshoots the turn. Hazard avoidance may override the user controls and the path following as shown. When the hazard becomes a red target, as described above, marine autopilot system 200 may take over and reduce the speed and turn vessel 104 away from hazard 708. As such, marine autopilot system 200 may avoid hazard 708 without input from the user. When hazard 708 is clear, either the user may navigate back to path 602 or marine autopilot system 200 may plot a trajectory to rejoin path 602 considering any additional hazards.

Furthermore, as illustrated in FIG. 7C, hazard warning 710 may be displayed to the user and audible and visual alerts may notify the user of hazard warning 710. Hazard warning 710 may recommend that the user adjust the speed based on hazard 708 or may notify the user that marine autopilot system 200 is taking full or partial control to avoid hazard 708. Hazard warning 710 may provide information related to hazard 708 such as classification, speed, and direction and the like. In some embodiments, hazard warning 710 may also be automatically displayed to the other vessel and instructions may be provided to the other vessel. In some embodiments, marine autopilot system 200 may sound an alarm such that users of the other vessel may be alerted to the hazard.

FIG. 8 depicts one example of a marine environment 102, which is a destination environment (e.g., marina). Typical destination environments comprise many hazards, such as, breakers, piers, docks, other vessels, speed limits, and the like in close quarters. Sensors 202 may be utilized to obtain data indicative of the destination environment and path 602 as planned to an open dock or a known owned dock of the user. As described above, the marine autopilot system may utilize all sensors 202 to detect hazards and control vessel 104 along path 602 while avoiding the hazards utilizing collision avoidance algorithms described above. Detected hazard information may include, for instance, the location, orientation, attitude, type, and duration of a hazard.

In some embodiments, predictions may be made based on a current state of marine environment 102 as detected by sensors 202. Other vessels may be detected and tracked, and future locations of the other vessels may be predicted based on time changes. For example, time for vessel 104 to arrive at dock 802 based on path 602 may be two minutes. First other vessel 804 may be currently in line with path 602; however, it is expected, based on the movement and direction of first other vessel 804, that first other vessel 804 will not be in line with path 602 in 1.5 minutes when vessel 104 reaches that point along path 602. Therefore, first other vessel 804 may not be determined to be a hazard. Furthermore, second other vessel 806 may currently be located past dock 802 but may be moving to exit the marina placing second other vessel 806 in line with path 602. Therefore, though second other vessel 806 is not currently in line with path 602, second other vessel 806 is predicted to be in line with path 602 when vessel 104 is there. Accordingly, second other vessel 806 may be designated as a hazard, and marine autopilot system 200 may implement collision avoidance to move past second other vessel 806. In some embodiments, this entire scenario may be implemented in SLAM as described in embodiments above.

In some embodiments, a detailed map of dock 802 may be generated using sensors 202. Specifically, LIDAR system 208 may be used to generate an accurate 3D map of dock 802 and a continual distance between vessel 104 and dock 802 may be tracked. In a marina, LIDAR system 208 could detect the objects. Furthermore, outside of the marina any typical radar can be used. In the marina radar may be restricted and typical marine radar and also, multi wave radar, or radar with 77 GHz can be used inside marina. Marine autopilot system 200 may use the dock mapping data to slowly propel vessel 104 into dock 802 and stop when vessel 104 is next to a side of dock 802 such that the user may tie down vessel 104. In some embodiments, marine autopilot system 200 may use LIDAR to determine an accurate location of a boat trailer and align vessel 104 with a boat trailer and propel vessel 104 onto the boat trailer for attachment by the user.

In some embodiments, the docking location may not be known. For example, a user may be getting gas at a shoreside gas station or may be docking at a shoreside restaurant. The user may display the shoreline along with other vessels docked along the shoreline and tap a location on display device 122 in which to dock vessel 104. A 4D map may be generated of the docking location using LIDAR system 208 as well as any of a variety of other types of sensors 202 and marine autopilot system 200 may slowly dock vessel 104 at the desired location. The 4D map may be a 3D map that continuously updates with distance measurements from LIDAR system 208 providing the most up-to-date data available.

FIG. 9 depicts one example of a weather system 900 and vessel route 902 through the weather system 900. In some embodiments, vessel 104 is a motorized boat and marine autopilot system 200 may compensate for the environmental conditions by angling the bow of the boat into currents or wind to compensate for crosswind and crosscurrent. Furthermore, one or more motors 106 may be adjusted to compensate for the crosswind and crosscurrent. In some embodiments, a controller may be used to compensate for the estimated crosswind and crosscurrent based on historical data, current readings, and physical models of the wind and current. The controller may be a machine learning algorithm, linear or nonlinear, or adaptive controller. Accordingly, robust control may be implemented for severe conditions such that a loose direction and speed may guide vessel 104 to shore when the conditions become extremely rough.

In some embodiments, marine autopilot system 200 may control vessel 104 to compensate for the weather conditions when vessel 104 is a sailboat. In some embodiments, marine autopilot system 200 provides end to end navigation and control for sailboats based on wind patterns. In some embodiments, weather data may be received in GRIB format and processed by marine autopilot system 200 to plan a path through the weather systems. Marine autopilot system 200 may determine optimal routes based on distance and time minimization based on tack/jibes movement and comfort of the user. The weather and wind direction may be tracked, and optimal tack/jibes changes may be displayed and/or notifications may be sent to the user directing the user when to change. In some embodiments, sail assist may automatically adjust sail control at the optimal times by controlling electromechanical actuators to control the sail.

In some embodiments, if the weather is hazardous or sailing is simply inefficient based on the weather, marine autopilot system 200 may automatically switch between various modes such as sailing and motorized propulsion. Marine autopilot system 200 may optimize routes based on sailing and motorized propulsion and switch seamlessly between each mode based on user input or sail and/or motor detection.

FIG. 10 depicts one example of a user interface 124 for interaction with marine autopilot system 200. It will be understood that various implementations of the marine autopilot system 200 may provide any one or more of the features described herein. In various implementations, the user may selectively enable and/or disable one or more of the features, the marine autopilot system 200 may automatically enable and/or disable one or more of the features under relevant circumstances, and one or more of the features may be simultaneously employable. For example, the object identification feature and the distance markers 410 may be simultaneously employed as shown in FIG. 10. For another example, the virtual boundary feature and/or the collision prediction feature and the automatic camera selection feature may be simultaneously employed.

User interface 124 enables the user to interact with marine autopilot system 200 based on information provided by the features described herein. For example, the user may select object 1002 on display device 122 to mark as a waypoint (and/or obstacle) for future navigational reference. Marine autopilot system 200 may utilize these stored locations, and/or other cartographic locations stored within the memory of marine autopilot system 200, to automatically transition camera views as the vessel approaches known objects. The user may likewise select displayed objects for tracking and monitoring by marine autopilot system 200 regardless of the particular camera view selected by the user (e.g., ship 1004). Additionally, or alternatively, the user may utilize the user interface 124 to select locations for automatic docking and navigation. For instance, a user may touch a desired location on a displayed image from one or more of the cameras, marine autopilot system 200 may determine the geographic location corresponding to the desired location, and marine autopilot system 200 may automatically navigate to the desired location using autopilot features and the detected object information. As one example, the user may select object 1002, which is the shoreline. The shoreline may be detected and classified, and GPS coordinates may be stored. Marine autopilot system 200 may navigate at a safe distance from the shoreline or may approach the shoreline and maintain a location a specified distance from the location that the user indicated. Furthermore, as described above, the user may touch various objects such as the shoreline and the water and the various objects may be displayed as different shades or different colors as simple visual cues for the user. The user interface 124 may present a plurality of trajectories for review and selection by the user. The presented information may include, for example, recommended changes in speed, direction, or operation of the vessel based on the location, orientation, speed, or other information associated with a hazard.

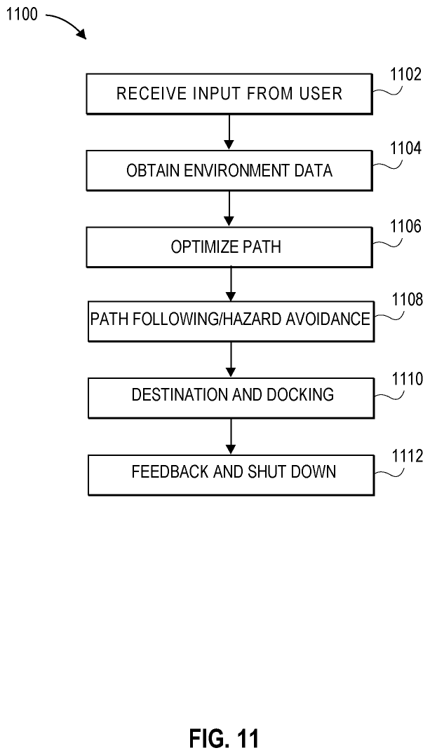

FIG. 11 depicts an exemplary flow chart 1100 illustrating operations for controlling a vessel through marine environment 102. At step 1102, marine autopilot system 200 may receive input from the user as described in embodiments above. The user may enter a destination and an optimization rule to calculate a path from the current location (or a starting point) to the destination location. The user may input the information by user interface 124 as part of interface 230.

At step 1104, marine autopilot system 200 may obtain data to optimize a route and generate a path through marine environment 102 as described in embodiments above. The marine environment data may be obtained from marine chart data, maps, satellite imagery, AIS, and the like. A virtual map of marine environment 102 may be generated such that an optimal route, based on the dynamic model of vessel 104 and an optimization rule, may be determined.

At step 1106, the dynamic model of vessel 104 along with an optimization rule may be used to calculate a route and generate path 602 through marine environment 102 as described in embodiments above. The optimization rule may be based on user comfort, speed, efficiency, sightseeing, or the like. The route may be determined and path 602 may be generated and displayed on display device 122 by marine autopilot system 200. In some embodiments, SLAM may be utilized to generate a virtual marine environment for prediction and simulation of marine environment 102. When predictions for the changing environment are made, and marine environment 102 is simulated, path 602 may be generated in the virtual environment to predict the behavior of vessel 104 in marine environment 102.

At step 1108, marine autopilot system 200 may control vessel 104 along path 602 as described in embodiments above. Marine autopilot system 200 may control vessel 104 to follow path 602 minimizing the error between path 602 and the trajectory of vessel 104. As such, vessel 104 may precisely follow path 602. Furthermore, sensors 202 may be used to detect hazards along path 602 and object avoidance algorithms may be used to change the trajectory of vessel 104 to avoid the hazards at step 1110. Boundaries may be virtually added to vessel 104 and hazards such that the boundaries may interact or overlap when vessel 104 and the hazards become too close. As a result of the overlapping boundaries, marine autopilot system 200 may avoid the hazards.

At step 1110, marine autopilot system 200 may enter destination and docking mode to dock vessel 104 as described in embodiments above. Marine autopilot system 200 may navigate a marine environment comprising many hazards in close quarters while docking vessel 104 in a specific location. Marine autopilot system 200 may control vessel 104 to reduce speed in the close quarters of a marina, and radar system 206 may be shut down or switched to marina-usable radar only. LIDAR system 208 may be utilized to obtain detailed images and locations of dock 802 for docking. Based on the detailed information provided by sensors 202, marine autopilot system 200 may dock vessel 104 completely autonomously.

At step 1112, marine autopilot system 200 may shut down vessel 104, store data associated with the trip, and request feedback from the user. The user may provide feedback based on their experience during the trip. This feedback may be used to provide a more user-friendly experience in the future. For example, the user may provide feedback on the comfort level of the trip. A stored comfort level assigned to the user may be updated based on the user feedback.

As described above, all features described herein may be customizable by the user. The user may define when boundaries are displayed, colors of hazards, highlighted hazards, path display color, vessel icon and display, and the like. Any features of marine autopilot system 200 may be turned on or off and the user may operate marine autopilot system 200 in manual, autonomous, or hybrid modes, as described above.

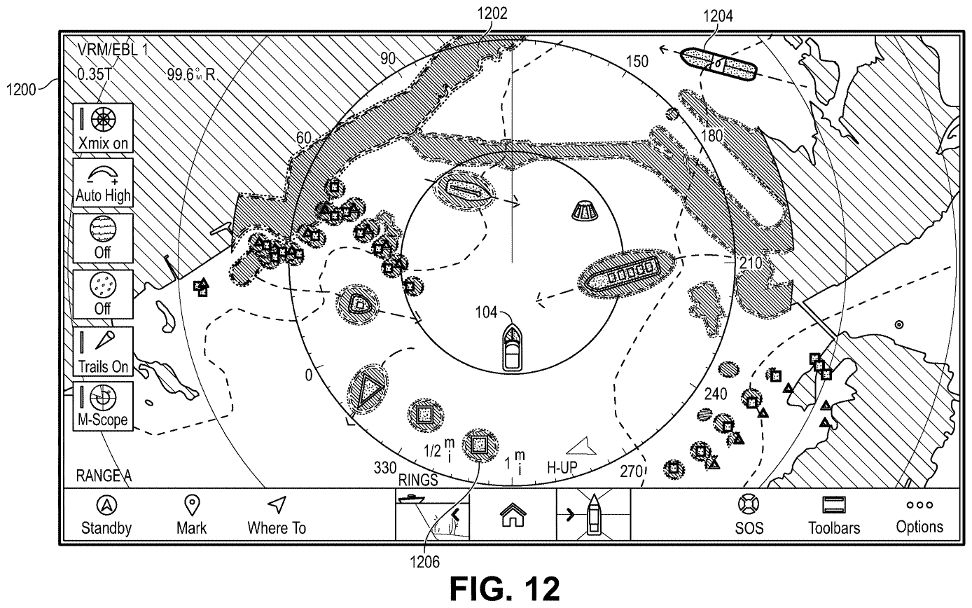

FIG. 12 is an exemplary user interface map displaying hazards fused from various sensor sources. The marine autopilot system may be configured to fuse data related to detected targets and objects from multiple onboard sensor sources, such as radar, cameras, and Automatic Identification System (AIS) receivers. This sensor data fusion process can involve integrating positional information, velocity vectors, object classification, and tracking data obtained individually from each sensor type. Once fused, the consolidated target and object information may be visually presented to the operator on a single, integrated display interface 1200. This integrated display interface 1200 is unified such that it can depict the combined sensor data in an intuitive manner, showing vessel positions, trajectories, and environmental hazards derived from the fused radar returns, AIS transponder data, and visual object recognition from cameras. This integrated view can assist the operator by providing clear situational awareness.

The integrated display interface 1200 visually represents potential collision situations detected by the marine autopilot system. Collision hazards such as land hazards 1202, moving target hazards 1204, stationary target hazards 1206 are indicated with unique symbols and color-coded markers in relation to the vessel 104 and/or the vessel's projected route.

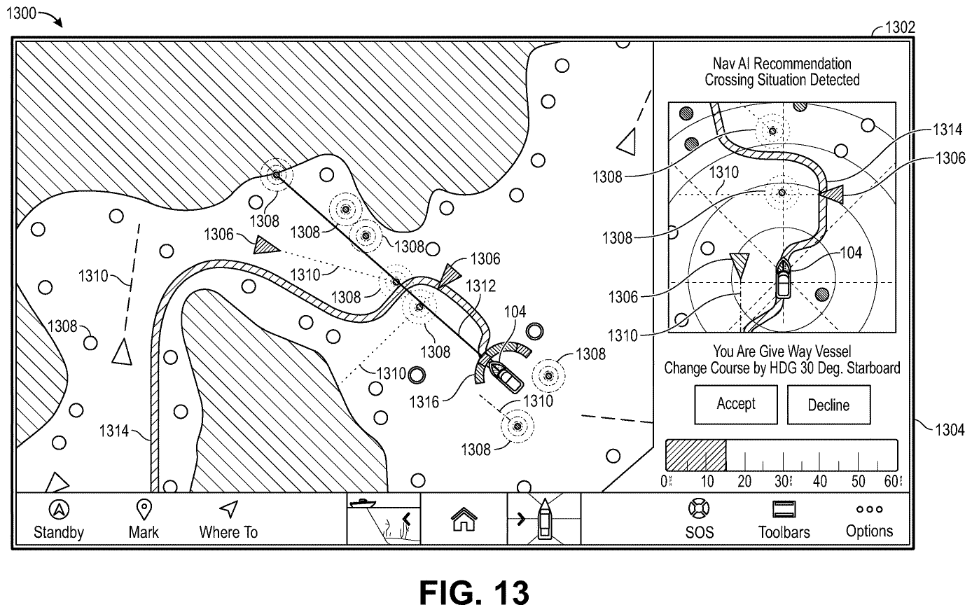

FIG. 13 is another exemplary user interface map 1300 displaying a proposed navigational path to avoid identified hazards and a recommendation display 1302 having an invitation for user input display 1304. Similar to FIG. 12, FIG. 13 includes moving hazards 1306 and stationary hazards 1308 with virtual boundaries. The moving hazards 1306 may include projected movement lines 1310 as calculated by the marine autopilot system 200 based upon the real-time data. Also shown is a current heading indicator 1312, which may change color to clearly distinguish different hazard categories, such as shallow-water areas or fixed obstacles, allowing users to easily differentiate among the various detected risks. The display may also include a recommended path 1314 which the user may accept via the invitation for user input display 1304 of the recommendation display 1302. The recommendation display 1302 depicts a vertical timeline that supplements the main graphical interface, presenting a top-down linear view indicating the estimated time to approach each identified collision hazard. This display graphically illustrates how soon each hazard will be encountered relative to the vessel's current position and speed, providing an immediate visual reference for prioritizing operator responses and decisions.

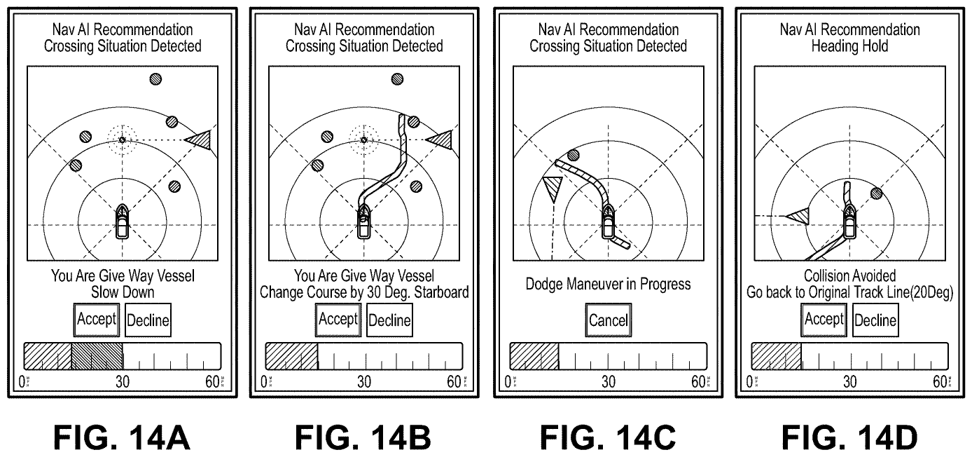

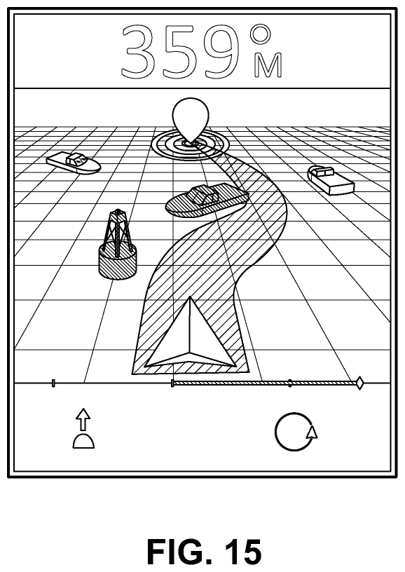

FIG. 14A-14D are other exemplary recommendation displays depicting a crossing situation calculated and recommended by the marine autopilot system. FIG. 14A indicates detection of the crossing situation along with a recommendation to slow down as a recommended maneuver. FIG. 14B indicates detection of the crossing situation with a recommendation to change course as a recommended maneuver. Depending on the situation, both a change in speed and a change in course may be the recommended maneuver. FIG. 14C shows the dodge maneuver in progress. FIG. 14D shows the return to the original track line following the dodge maneuver. FIG. 15 depicts an alternate exemplary user interface depicting the crossing situation which is a 3D depiction rather than the 2D depictions of FIGS. 12, 13, and 14A-D.

The heading indicator 1312 displayed on the interface may dynamically change color based on the assessed level of collision risk detected along the vessel's current trajectory. Similar functionality may also be implemented for the route line itself. Such color-based changes can visually convey increasing or decreasing hazard levels along planned or active paths, assisting operators in quickly evaluating navigation scenarios.

Returning to FIG. 13, the user interface map 1300 may include a gauge 1316 that is circular or arcuate and surrounding the vessel's icon, providing immediate visual feedback regarding safe and unsafe headings relative to the vessel's current position and/or detected hazards. This gauge 1316 is color-coded to intuitively inform the user about potential collision risks in each direction. For example, sections of the gauge 1316 appearing in green indicate headings that have been determined as safe and clear of detected hazards, allowing the user to confidently steer in those directions. Conversely, areas shown in red represent headings associated with higher collision risks, alerting users that turning toward those directions may result in unsafe conditions or collisions.

The gauge 1316 may continuously update in real-time as the marine autopilot system gathers and analyzes sensor data from radar, cameras, AIS, and other detection methods. As conditions in the marine environment change, the gauge colors can dynamically shift, reflecting evolving hazards and updated safety assessments. This real-time responsiveness provides immediate situational awareness, enabling the vessel operator to quickly evaluate alternative headings, confirm safety, and effectively manage navigation decisions under varying circumstances. In some embodiments, the gauge 1316 reflects aggregated collision risk associated with multiple detected hazards simultaneously, such that safe and unsafe headings are determined based on combined predicted positions and trajectories of more than one object relative to the vessel.

The gauge 1316 representing varying degrees of collision risk may be displayed in multiple locations within the graphical user interface, based on user preferences or system configurations. For instance, the gauge 1316 can appear surrounding the icon of the vessel 104 on a map page (as shown in FIG. 13), indicating relative hazard levels associated with different directional headings in the context of surrounding geographic and navigational features. Additionally, the gauge 1316 can be included within a dedicated autopilot control page with a recommendation display 1302 (such as those shown in FIGS. 13 and 14A-D), emphasizing directional hazard information as part of active route management and collision avoidance functions. Alternatively, the gauge 1316 may be presented along the margin or edge of the display, providing continuous awareness of directional hazard conditions without interfering with primary navigation data or obstructing the main viewing area.

The marine autopilot system may include functionality configured to autonomously detect potential collision situations and implement maneuvers consistent with standard marine overtaking and passing procedures. Specifically, the autopilot can continuously analyze vessel trajectories, comparing current and predicted paths of the user's vessel with those of surrounding vessels to optionally identify overtaking, head-on, and crossing scenarios. Upon detecting such situations, the autopilot may calculate appropriate collision-avoidance maneuvers, optionally considering factors such as relative vessel speeds, proximity, navigational constraints, environmental conditions, and maritime navigation rules.

As used herein, a navigational constraint may include, without limitation, a charted no-wake zone, a speed limit zone, a channel boundary, a traffic separation scheme boundary, a restricted area, a prohibited area, a shallow-water boundary, an anchorage area boundary, a marine protected area boundary, and any other geographic or regulatory feature that constrains the permissible movement of vessel 104 within marine environment 102. Navigational constraints may be obtained from charts 226, from community data 228, from sensors 202, or from any combination thereof. As used herein, an environmental condition may include, without limitation, a wind speed, a wind direction, a current speed, a current direction, a wave height, a wave period, a visibility distance, a precipitation type and intensity, a water temperature, an air temperature, a barometric pressure, and a tide level. Environmental conditions may be obtained from wind sensor 222, weather detection system 214, other sensors 202, community data 228, externally received weather data including data in GRIB format, or any combination thereof. The marine autopilot system 200 may take into account one or more navigational constraints and one or more environmental conditions when generating the recommended maneuver, such that the recommended maneuver complies with applicable navigational constraints and is feasible under the current environmental conditions.

In some embodiments, the marine autopilot system may store, on a non-transitory computer readable storage medium, a set of maritime navigation rules accessible to the processor for use in generating recommended maneuvers. The set of maritime navigation rules may comprise rules derived from the International Regulations for Preventing Collisions at Sea (COLREGs), United States Inland Navigation Rules, regional or local navigation conventions, harbor-specific regulations, or any combination thereof. Each rule in the set may be associated with one or more encounter classifications such that, given a particular encounter classification, the processor may identify and retrieve one or more applicable rules from the set. Encounter classifications may include overtaking encounters, head-on encounters, crossing encounters, restricted-visibility encounters, narrow-channel encounters, encounters within traffic separation schemes, encounters involving stand-on and give-way determinations, and encounters with non-vessel hazards such as shoals, fixed obstructions, restricted areas, and shallow-water boundaries. The set of maritime navigation rules may be updated periodically and/or upon entering a new geographic area by the marine autopilot system, for example by receiving rule updates from a remote server, from community data 228, or from user input via interface 230.

When a potential collision scenario is detected, the marine autopilot system 200 may generate recommended dodge paths or speed-reduction maneuvers. These recommendations can be derived from real-time vessel data and sensor information, optionally aligning with established maritime collision-avoidance procedures. Recommended dodge maneuvers may consider vessel dynamics, environmental conditions, and other detected hazards, assisting in maintaining navigational safety and compliance with standard maritime practices.

After the marine autopilot system 200 provides recommended dodge maneuvers, the autopilot may await user acknowledgment prior to executing the maneuvers. The user can review and confirm proposed collision-avoidance actions, retaining control over vessel operation. Upon receiving acknowledgment, the autopilot may autonomously execute the recommended path alteration or speed adjustment, thereby optionally enabling timely and precise responses to navigational hazards and potential collisions.

Upon receiving user acknowledgment of a recommended maneuver, the marine autopilot system 200 may translate the recommended maneuver into one or more control commands and issue the control commands to control system 250 for execution. For example, a recommended dodge path may be translated into a sequence of steering commands issued to steering control module 254, and a recommended speed reduction may be translated into one or more throttle commands issued to speed control module 252. In some embodiments, the marine autopilot system 200 may issue commands to both steering control module 254 and speed control module 252 simultaneously to execute a combined course-and-speed maneuver. In some embodiments, the user may retain partial control of vessel 104 during execution of the recommended maneuver, such as by retaining control of the throttle while marine autopilot system 200 controls steering, or vice versa, consistent with the hybrid control modes described above. In some embodiments, the marine autopilot system 200 may monitor execution of the recommended maneuver in real-time using sensors 202 and may adjust the control commands as needed to compensate for environmental conditions, vessel dynamics, or changes in the position or trajectory of the at least one hazard.

The marine autopilot system 200 may determine the specific navigational scenario—such as overtaking, head-on, or crossing—by continuously analyzing sensor data and positional information from sources such as radar, AIS, GPS, and onboard cameras. The system can calculate relative bearings, courses, and speeds of nearby vessels to ascertain their trajectories relative to the user's vessel. Based on these calculated trajectories and relative orientations, the system may classify each navigational interaction according to established maritime standards. An example of a specific navigational scenario being a crossing situation is shown in FIGS. 14A-D.

Upon classifying a particular encounter, the marine autopilot system 200 may query the stored set of maritime navigation rules using the encounter classification as a key and retrieve one or more applicable rules corresponding to that classification. For example, upon classifying an encounter as a crossing encounter in which vessel 104 is the give-way vessel, the marine autopilot system 200 may retrieve one or more rules specifying that vessel 104 should alter course to starboard to pass astern of the stand-on vessel. As another example, upon classifying an encounter as a head-on encounter between two power-driven vessels, the marine autopilot system 200 may retrieve one or more rules specifying that each vessel should alter course to starboard so as to pass on the port side of the other. The retrieved rules may then be applied as constraints by the processor when computing the recommended maneuver, such that the recommended maneuver complies with the retrieved rules to the extent practicable given the vessel dynamics of vessel 104, the environmental conditions in marine environment 102, and the positions and trajectories of other detected hazards. In some embodiments, the rule retrieval may be performed by a lookup operation, a database query, a decision tree, a rules engine, a trained machine learning model, or any combination thereof.

In some embodiments, the marine autopilot system 200 may identify multiple applicable rules for a given encounter, for example when vessel 104 is involved in a crossing encounter while simultaneously navigating within a narrow channel or a traffic separation scheme. In such cases, the marine autopilot system 200 may apply a priority hierarchy among the applicable rules, may combine the constraints imposed by multiple rules into a single set of constraints, or may select among the applicable rules based on factors such as the severity of the collision risk, the maneuverability of vessel 104, the maneuverability of the other vessel or vessels involved, and the proximity of fixed obstructions. In some embodiments, the priority hierarchy may be predefined and stored on the non-transitory computer readable storage medium. In some embodiments, the priority hierarchy may be configurable by the user via interface 230. When the constraints imposed by two or more applicable rules cannot be simultaneously satisfied, the marine autopilot system 200 may select the recommended maneuver that best satisfies the highest-priority rule while minimizing the deviation from the remaining applicable rules. The marine autopilot system 200 may additionally provide an alert or other indication to the user that the two or more applicable rules cannot be simultaneously satisfied.

Upon identifying a particular situation, the autopilot system may apply navigational rules specific to that scenario. For example, if the system determines an overtaking scenario, it may suggest maneuvering to pass at a prescribed distance, maintaining course and speed adjustments that adhere to maritime conventions. Similarly, for head-on or crossing scenarios, the system may recommend specific course alterations or speed changes consistent with established marine collision-avoidance protocols. Each maneuver recommendation may be generated by taking into account the precise type of encounter, current vessel dynamics, surrounding environmental conditions, and applicable maritime regulations.

In some embodiments, the marine autopilot system 200 may record, on the non-transitory computer readable storage medium, a log of encounter events for later review. For each encounter event, the log may include one or more of: a timestamp, the real-time data received from sensors 202 at or near the time of the encounter, the encounter classification determined by the processor, the one or more maritime navigation rules retrieved from the stored set in connection with the encounter, the recommended maneuver generated by the processor, an indication of whether the user acknowledged the recommended maneuver, the control commands issued to control system 250 in connection with execution of the recommended maneuver, and the resulting trajectory of vessel 104. The log may be stored locally on vessel 104, transmitted to a remote server, or both. The log may be made available for later review by the user, by a vessel operator, by a fleet manager, by an insurer, or by a regulatory authority, and may be used to support post-incident analysis, training, retraining of machine learning components of the marine autopilot system 200, or compliance verification.

As shown above, the marine autopilot system 200 may also provide a route guidance feature that functions similarly to the dodge capability but is specifically focused on returning the vessel to its originally planned route following an avoidance maneuver. After executing a collision-avoidance action, the route guidance feature can calculate and recommend adjustments in heading and speed to bring the vessel back onto the predefined route efficiently. These recommended adjustments may be based on real-time sensor data, vessel dynamics, and environmental conditions, ensuring alignment with maritime navigation conventions while maintaining compliance with the user's previously selected navigation plan.

In some embodiments, the route guidance feature may also consult the stored set of maritime navigation rules when calculating adjustments to return vessel 104 to the originally planned route. For example, the route guidance feature may avoid recommending a return maneuver that would place vessel 104 in violation of a maritime navigation rule, such as crossing ahead of a stand-on vessel or entering a restricted area. The route guidance feature may instead recommend a return path that complies with all applicable maritime navigation rules while minimizing the additional time, distance, or fuel required to rejoin the originally planned route.

Although embodiments of the invention have been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A marine autopilot system for a vessel, the system comprising:
a plurality of sensors disposed on the vessel and configured to generate real-time data indicative of a marine environment surrounding the vessel,
a non-transitory computer readable storage medium storing a set of maritime navigation rules; and
a processor communicatively coupled to the plurality of sensors and to the computer readable storage medium, the processor configured to:
receive the real-time data from the plurality of sensors;
identify, from the real-time data, at least one hazard in the marine environment relative to the vessel;
determine, based at least in part on the real-time data, an encounter classification between the vessel and the at least one hazard;
select, from the set of maritime navigation rules, at least one maritime navigation rule corresponding to the encounter classification;
generate a recommended maneuver for the vessel based at least in part on the selected at least one maritime navigation rule and the at least one identified hazard; and
output the recommended maneuver via a user interface of the vessel.

2. The marine autopilot system of claim 1, wherein the plurality of sensors comprises at least two of a camera system, a radar system, a LIDAR system, a sonar system, an Automatic Identification System (AIS) receiver, a GPS receiver, an inertial measurement unit, a wind sensor, and a weather detection system.

3. The marine autopilot system of claim 1,
wherein the encounter classification comprises one of an overtaking encounter, a head-on encounter, and a crossing encounter between the vessel and the at least one hazard,
wherein the processor is further configured to determine the encounter classification at least in part by calculating at least one of a relative bearing, a relative course, and a relative speed between the vessel and the at least one hazard.

4. The marine autopilot system of claim 1, wherein the at least one hazard comprises a second vessel, and wherein the processor is further configured to:
determine a maneuverability characteristic of the second vessel; and
generate the recommended maneuver based at least in part on the determined maneuverability characteristic of the second vessel.

5. The marine autopilot system of claim 1, wherein the processor is further configured to:
receive, via the user interface, a user acknowledgment of the recommended maneuver; and
autonomously execute the recommended maneuver by commanding at least one of a steering control and a speed control of the vessel responsive to receiving the user acknowledgment.

6. The marine autopilot system of claim 1, wherein the processor is further configured to:
fuse data from two or more of the plurality of sensors to generate consolidated target information for the at least one hazard;
predict a future position of the at least one hazard based at least in part on the real-time data;
instruct display of the consolidated target information on the user interface; and
generate the recommended maneuver based at least in part on the predicted future position.

7. The marine autopilot system of claim 1,
wherein the user interface comprises a graphical display, and
wherein outputting the recommended maneuver comprises causing the graphical display to present a gauge at least partially surrounding an icon of the vessel, the gauge being color-coded to indicate safe headings and unsafe headings relative to the at least one identified hazard.

8. The marine autopilot system of claim 1, wherein the recommended maneuver is generated based further on at least one of a vessel dynamic characteristic, an environmental condition in the marine environment, and a navigational constraint in the marine environment.

9. A marine autopilot system for a vessel, the system comprising:
a plurality of sensors disposed on the vessel and configured to generate real-time data indicative of a marine environment surrounding the vessel,
a non-transitory computer readable storage medium storing a set of maritime navigation rules; and
a processor communicatively coupled to the plurality of sensors and to the computer readable storage medium, the processor configured to:
receive the real-time data from the plurality of sensors;
identify, from the real-time data, at least one hazard in the marine environment relative to the vessel;
determine, based at least in part on the real-time data, an encounter classification between the vessel and the at least one hazard;
select, from the set of maritime navigation rules, at least one maritime navigation rule corresponding to the encounter classification;
generate a recommended maneuver for the vessel based at least in part on the selected at least one maritime navigation rule and the at least one identified hazard;
output the recommended maneuver via a user interface of the vessel;
receive, via the user interface, a user acknowledgment of the recommended maneuver; and
autonomously execute the recommended maneuver by commanding at least one of a steering control and a speed control of the vessel responsive to receiving the user acknowledgment.

10. The marine autopilot system of claim 9, wherein the plurality of sensors comprises at least two of a camera system, a radar system, a LIDAR system, a sonar system, an Automatic Identification System (AIS) receiver, a GPS receiver, an inertial measurement unit, a wind sensor, and a weather detection system.

11. The marine autopilot system of claim 9,
wherein the encounter classification comprises one of an overtaking encounter, a head-on encounter, and a crossing encounter between the vessel and the at least one hazard,
wherein the processor is further configured to determine the encounter classification at least in part by calculating at least one of a relative bearing, a relative course, and a relative speed between the vessel and the at least one hazard.

12. The marine autopilot system of claim 9, wherein the at least one hazard comprises a second vessel, and wherein the processor is further configured to:
determine a maneuverability characteristic of the second vessel; and
generate the recommended maneuver based at least in part on the determined maneuverability characteristic of the second vessel.

13. The marine autopilot system of claim 9, wherein the processor is further configured to:
fuse data from two or more of the plurality of sensors to generate consolidated target information for the at least one hazard;
predict a future position of the at least one hazard based at least in part on the real-time data;
instruct display of the consolidated target information on the user interface; and
generate the recommended maneuver based at least in part on the predicted future position.

14. The marine autopilot system of claim 9,
wherein the user interface comprises a graphical display, and
wherein outputting the recommended maneuver comprises causing the graphical display to present a gauge at least partially surrounding an icon of the vessel, the gauge being color-coded to indicate safe headings and unsafe headings relative to the at least one identified hazard.

15. A marine autopilot system for a vessel, the system comprising:
a plurality of sensors disposed on the vessel and configured to generate real-time data indicative of a marine environment surrounding the vessel, a non-transitory computer readable storage medium storing a set of maritime navigation rules;
a display; and
a processor communicatively coupled to the plurality of sensors and to the computer readable storage medium, the processor configured to:
receive the real-time data from the plurality of sensors;
identify, from the real-time data, at least one hazard in the marine environment relative to the vessel;
determine, based at least in part on the real-time data, an encounter classification between the vessel and the at least one hazard;
select, from the set of maritime navigation rules, at least one maritime navigation rule corresponding to the encounter classification;
generate a recommended maneuver for the vessel based at least in part on the selected at least one maritime navigation rule and the at least one identified hazard;
output the recommended maneuver via a graphical user interface rendered on the display;
present, on the graphical user interface, a gauge in relation to an icon of the vessel, the gauge being color-coded to indicate safe headings and unsafe headings relative to the at least one identified hazard.

16. The marine autopilot system of claim 15, wherein the plurality of sensors comprises at least two of a camera system, a radar system, a LIDAR system, a sonar system, an Automatic Identification System (AIS) receiver, a GPS receiver, an inertial measurement unit, a wind sensor, and a weather detection system.

17. The marine autopilot system of claim 15,
wherein the encounter classification comprises one of an overtaking encounter, a head-on encounter, and a crossing encounter between the vessel and the at least one hazard,
wherein the processor is further configured to determine the encounter classification at least in part by calculating at least one of a relative bearing, a relative course, and a relative speed between the vessel and the at least one hazard.

18. The marine autopilot system of claim 15, wherein the at least one hazard comprises a second vessel, and wherein the processor is further configured to:
determine a maneuverability characteristic of the second vessel; and
generate the recommended maneuver based at least in part on the determined maneuverability characteristic of the second vessel.

19. The marine autopilot system of claim 15, wherein the processor is further configured to:
fuse data from two or more of the plurality of sensors to generate consolidated target information for the at least one hazard;
predict a future position of the at least one hazard based at least in part on the real-time data;
instruct display of the consolidated target information on the graphical user interface; and
generate the recommended maneuver based at least in part on the predicted future position.

20. The marine autopilot system of claim 15, wherein the processor is further configured to:
receive, via the graphical user interface, a user acknowledgment of the recommended maneuver; and
autonomously execute the recommended maneuver by commanding at least one of a steering control and a speed control of the vessel responsive to receiving the user acknowledgment.
